(19) United States
(12) Patent Application Publication
(10) Pub. No.: US 2006/0098286 A1
(43) Pub. Date: May 11, 2006

(54) Retroreflective materials

(76) Inventors: Brian Sagar, Cheshire (GB); Peter A. White, Cheshire (GB)

Correspondence Address: CHARLES E. BAXLEY, ESQ., 90 JOHN STREET, THIRD FLOOR, NEW YORK, NY, 10038, US

(21) Appl. No.: 11/293,011

(22) Filed: Dec. 2, 2005

Related U.S. Application Data
(62) Division of application No. 09/658,550, filed on Sep. 8, 2000, now abandoned.

(51) Int. Cl. G02B 5/124

(52) U.S. Cl. 359/530

(57) ABSTRACT

A retroreflective studio background or backdrop material to which is applied an ink comprising retroreflective elements in a polymeric matrix, the ink being one which comprises comprises retroreflective elements and microbeads additional to said retroreflective elements, binder chemicals for attaching the retroreflective elements and microbeads to a substrate to which the ink is applied and a coupling agent for coupling the microbeads and cross-links the binder chemicals, the coupling agent being unreactive until the ink application process is carried out.

The present Application is a Divisional Application with respect to U.S. application Ser. No. 09/658,550 filed Sep. 8, 2000 currently pending in Art Unit 2612 before Examiner James H HANNETT.

This invention relates to retroreflective materials, and particularly to such materials as are proposed in GB 2 321 565 for use as studio backdrops for chroma-keying and like purposes. As used herein, the term “backdrop” is to be understood as referring not only to television studio backgrounds or backdrops but also backdrops in the form of special effects screens as used in for example film sets and studios. Chroma-keying refers to the technique, used in film-making and video imaging, of superimposing a foreground image shot by a camera on to a background which has been previously recorded or which is generated by a computer.

According to GB 2 321 565, such a studio background material for chroma-keying is made of a flexible sheet material coated with a plurality of retroreflective particles, randomly orientated. Usually, the retroreflective particles are glass microbeads which have been hemispherically coated with aluminium. In order to provide for high retroreflectivity at angles of incidence other than normal to the surface, GB 2 321 565 teaches that the material surface is not smooth, but has hills and troughs of size comparable to the diameter of the beads so that when viewed from an oblique angle, a substantial proportion of the spheres will be visible. This is said to produce substantially uniform reflectivity over a wide range of entrance angles.

Such uniformity is, of course, highly desirable for chroma-keying as well as for virtual studio effects, produced by projecting an image from the camera position on to a retroreflective background. Actors and props which do not retroreflect are not noticeably illuminated by the projection and appear to the camera to be in front of a real background. In situations where the viewing angle is wide, or where cameras are mobile, it is clearly important that the virtual image or chroma-key colour is of the same intensity from any angle.

GB 2 321 565 claims to achieve a normalised retro-reflectivity of at least about ¼ at an angle of incidence of at leat 60 degrees to the normal.

The retroreflective fabric is made, according to GB 2 321 565, by spray-coating or painting a thin layer of adhesive on to the cloth, or applying a thin flexible sheet adhesive, for example that available from 3M Corporation under the trade name “Scotch”. Suitable reflective spherical particles are said to be available from 3M as part of their reflective ink Kit 8010. These are intended to be embedded in an adhesive supplied with the ink Kit and applied to a smooth surface as a reflective ink. Improved performance is, however, said to be achieved, particularly at large angles of incidence, if the particles are disposed on a separate adhesive layer, i.e. not used in an ink formulation.

GB 2 321 565 shows in graphical form (FIG. 4) a comparison of the normalised gain of a conventional retro-reflective sheet material (as sold by 3M) and of a retro-reflective material according to the method of the invention of GB 2 321 565, from which it can be seen clearly that the invention provides more uniform reflectivity, particularly at large angles of incidence.

The present invention provides retroreflective studio background materials, and methods for using and making the same, which have improved performance, in terms of uniformity of normalised gain, and which are easier to make, as well as being more versatile.

According to one aspect of the invention there is provided a retroreflective studio backdrop or backdrop material to which is applied to, e.g. as by printing or coating, a one-pack ink comprising retroreflective elements in a polymeric matrix and which has a retroreflectivity that remains substantially uniform from normal (0° ) to high (60°+) angles of incidence, e.g. as may be encountered during panning and/or tilting of a camera during televising, filming or recording a subject or subjects against the backdrop.

The ink may be applied directly to a wall or other fixed surface within a studio installation, such surface constituting a backdrop. More usually however, the ink is applied to a surface of a backdrop material which desirably is flexible and drapable so that it can be draped over a surface or surfaces which may not necessarily be flat or free of changes in curvature or sharp edges.

The normalised retroreflectivity is desirably maintained to such as an extent that it is at least about ¼, preferably at least about ⅓ and more preferably at least about ½, at an angle of incidence of at least 60 degrees to normal, more preferably at least 70 or 80 degrees to normal.

As used herein, “normalised” retroreflectivity or gain has the meaning defined in GB Patent No. 2321565.

The substrate to which the ink is applied, e.g. as by printing or coating, may have a surface structure contributing to said substantially uniform retroreflectivity.

The substrate material may be one having a smooth surface with the ink applied, e.g printed or coated, on to the smooth surface thereof. Alternatively the substrate material may have a relatively rough surface on to which the ink is applied. In either case, the substrate material may comprise a woven fabric having warp and weft crowns, or it may comprise a knitted fabric having a stitch structure. In the case of a relatively rough surface, the warp and weft crowns or the stitch structure will be conspicuous.

The “grain” of the fabric is preferably less than the resolution of a camera at the intended minimum camera-backdrop distance. In the case of material with a smooth surface, the substrate is typically such that substantially all of the retroreflective elements are at least to some extent proud of any surface structure of the substrate material, e.g. any peaks (for instance, warp and weft crowns or knitted stitch structure).

The ink may be applied to the backdrop material in solid colour for chroma-keying, or it may be printed in a pattern or design. The material may carry different colours of retroreflective ink, or may carry a single colour of retroreflective ink, over-printed with a pattern or design, as by transfer, e.g. heat transfer printing. Ink colouring may be secured by the addition of suitable colouring agents, e.g. pigments.

For certain applications, notably where printed or coated with retroreflective inks, for example for backdrops and special effects screens in film and television studios, it is desirable that fabrics used are fireproof, or fire retardant. The specialised nature of some retroreflective inks, however, raises problems in connection with many normally fireproof or fire retardant fabric materials.

Especially in studio situations, an increased risk of fire hazard may arise particularly where lighting gives rise to elevated temperatures and low relative humidity. To this end, the backdrop or backdrop material may be made fireproof or flame retardant, e.g. by application of a fire retardant agent. Thus, in accordance with a preferred feature of the invention, the backdrop or backdrop material comprises a fireproof or fire retardant fabric to which said retroreflective ink is applied, the fabric comprising a structural component that chars before it melts; for instance the fabric may be or contain, for example, cotton or other cellulosic fibres to which a fire retardant agent has been applied. The fabric may however comprise an inherently non-flam fibre.

The fabric may be made fireproof or fire retardant by application of a fire retardant agent, such as the commercially available Proban® or Pyrovatex®, to cellulosics, or it may be naturally fireproof or fire retardant, such as an aramid.

Desirably the ink is non-burning once applied to the backdrop or backdrop material, the ink being aqueous-based, non-aqueous based or plastisol based. The polymeric matrix may comprise polyvinylidene chloride or polyvinyl chloride. Examples of suitable aqueous-based inks for this purpose are given hereinafter in Tables 2 and 3.

The ink used in the production of a backdrop or backdrop material in accordance with the invention may be one which, prior to application to the substrate of the backdrop or backdrop material, comprises retroreflective elements, microbeads additional to said retroreflective elements and/or constituting said retroreflective elements at least in part, binder chemicals for attaching the retroreflective elements and microbeads to a substrate to which the ink is applied, and a coupling agent for coupling the microbeads and cross-linking the binder chemicals, the coupling agent being unreactive until the ink application process, e.g. by printing or coating, is carried out.

Such an ink may be formulated as a one or two-pack retroreflective ink.

A one-pack ink produced using the above combination of ingredients may have a storage life of not less than 3 months, preferably not less than 6 months and more preferably not less than 12 months when stored under ambient conditions (i.e. a temperature of about 20° C.). Also such inks, when stored for prolonged periods of 3 months or more under ambient conditions, show no significant change in rheology while retaining adequate retroreflectivity properties and durability to laundering.

Such a retroreflective one-pack ink may retain a viscosity of between 10 and 30 pascal after storage for not less than 3 months, preferably not less than 6 months and more preferably not less than 12 months, and may also exhibit laundering durability such that retroreflectivity is not reduced by more than 40% (preferably by not more than 30% and more preferably by not more than 20%) when applied to a substrate in the form of a cotton, nylon or polyester and laundered for 5 cycles in accordance with ISO 6330, method 5A.

Backdrops produced using inks as disclosed herein have been found to possess good abrasion resistance. More specifically, a backdrop may be such that, when subjected to 5000 cycles in the Martindale Test in accordance with BS EN 530, Method 2, using the woollen abradant, at least 60%, more preferably at least 70% and most preferably at least 90%, of the retroreflective beads are retained on the backdrop.

The coupling agent is usually one which is substantially unreactive at ambient temperature, namely 20° C. Typically the coupling agent is unreactive except at elevated temperature at which the printed or coated substrate is cured, e.g. a temperature within the range of 60 to 200° C., e.g. 130 to 180° C.

The coupling agent may be rendered active by elevated temperature; however, we do not exclude the possibility that the coupling agent may be rendered active by other means such as exposure to UV light or other high energy radiation.

Typically the binder is polymeric and the coupling agent serves to couple the beads to the polymeric binder.

Viewed from another aspect, the ink may be constituted by a one-pack or a two-pack retroreflective ink comprising microbeads in a liquid carrier medium including binder chemicals for attaching the microbeads to a substrate to which the ink is to be applied, the microbeads being incorporated in the carrier medium, and a coupling agent which couples the microbeads and cross-links the binder chemicals, characterised in that the coupling agent is not activated until the ink is applied, e.g as by printing or coating.

In the case of a two-pack system, a separate pack is provided for the coupling agent.

The ink may comprise retroreflective and/or non-retroreflective microbeads. Typically the proportion of microbeads which do not have a retroreflective coating constitute no more than 50% of the total microbead content but may be up to 100% when reflective flakes (e.g. flake mica) maybe used in conjunction with microbeads to provide retroreflectivity.

The binder and coupling agent may be selected from, but is not limited to, the following combinations:
polyvinylidene chloride copolymer as binder and (3-aminopropyl) silanetriol and/or blocked 1,6 hexamethylene diisocyanate trimer as coupling agent;
an acrylic copolymer as binder and (3-aminopropyl) silanetriol and/or blocked 1,6 hexamethylene diisocyanate trimer as coupling agent; and
polyurethane as binder and blocked 1,6 hexamethylene diisocyanate trimer as coupling agent.

The microbeads may have an aluminium coating, and may be pre-treated with a silicate before inclusion in the ink. They may for instance be pretreated with sodium silicate. They may be treated with a silane, especially a silane having a reactive group such as an amino group, which treatment may be after a silicate treatment and before inclusion in the ink. A suitable amino silane is bis-[gamma-(trimethoxysilyl)propyl]amine.

The ink may comprise a colouring agent such as a pigment, and may, especially when comprising pigment, comprise non-retroreflective, which usually means un-metallised, microbeads. The colouring agent/pigment content is typically up to 5% by weight of the ink. If desired, colour may be imparted by using microbeads to which a layer of colour, e.g. a coloured lacquer, is applied or which are composed of a tinted material such as tinted glass.

The microbeads may be pretreated before metallisation with stannous chloride.

The ink may be formulated—as to, e.g. viscosity, particle size—suitably for screen printing. The microbeads may have a median size in the range of 10 to 100 microns, e.g. 25 to 70 microns. Typically in the case of inks using metallised retroreflective microbeads, the median size is about 40 microns whereas in the case of inks using non-retroreflective microbeads in conduction with other reflective elements such as reflective flake particles, the microbeads typically have a median size of about 60 microns.

The microbeads, whether retroreflective or not, are preferably composed of high refractive index glass, such as a titanium/barium based glass with a refractive index in the range of 1.8 to 2.2, e.g. about 1.9.

The microbead density is typically in the range of 2000 to 20000 per square centimetre of substrate.

The ink may comprise a humectant, which may comprise urea and/or 2,3 propane diol, and may be water-based. It may comprise a buffer, to ensure an appropriate pH, such buffer, for example, comprising an ammonium phosphate buffer or a sodium phosphate buffer. A dispersant may also be included, as may a defoamer, a thickening agent, a cross-linking agent and a softening agent.

Other constituents that may be present in the ink may be selected from the group comprising carbon black; UV absorbing material; anti-scuffing agent, optionally a silicone or fluoropolymer; light spill-suppressing agent; anti-static agent and water repellant agent, optionally a silicone or fluoropolymer.

Non-water based inks may also be comprised within the invention. In this case, the need to protect the aluminium coating against attack in water-based media may be less important.

Surprisingly, having regard to the teaching of U.S. Pat. No. 5,650,213, substantially better quality inks—in terms of reflectivity, washfastness, abrasion resistance and shelf life—are produced with binder to bead volume ratios equal to or less than 50%. Essentially, more beads can be attached using less obscuring binder, more firmly and more permanently than when the prior art binder to bead ratios are used.

For a screen printing ink, the viscosity is desirably equal to or less than 40 pascals, preferably between 10 and 30 pascals, at room temperature.

The invention also resides in a method for producing a substrate for use as a studio backdrop or backdrop material which exhibits a retroreflectivity that remains substantially uniform from normal (0°) to high (60°+) angles of incidence, said method comprising the steps of:
making microbeads;
suspending microbeads and reflective elements in a liquid carrier medium comprising binder chemicals for attaching the microbeads to the substrate to which the ink is to be applied and a coupling agent which couples the microbeads and cross-links the binder chemicals, the coupling agent being unreactive except at elevated temperature (e.g. within the range from 60 to 200° C. and usually from 130 to 180° C.) at which the ink-carrying substrate is cured, the reflective elements optionally being constituted at least in part by the microbeads,
applying, e.g. as by coating or printing, the liquid carrier medium on to said substrate, and
causing or allowing the coupling agent to react during and/or after said ink application step.

The method may involve the application of an aluminium coating to glass microbeads. The microbeads may be pretreated with stannous chloride prior to application of the aluminium coating, and may be treated with a dilute solution of stannous chloride.

The microbeads may be hemispherically metallised in a vacuum metallising process in which they are held on a film with an adhesive coating for transport through the metallising process, the adhesive coating comprising a styrene/butadiene type or other adhesive, which loses its tack when wet. The film may comprise a polyester or polyolefin film. Following metallisation, the film may be passed through an aqueous solution of citric acid or other aqueous solution with a pKₐ value of around 2, and may be treated ultrasonically to assist in release of the microbeads from the adhesive surface. In contradistinction to other methods for attachment of beads for metallisation, this method is easier at least inasmuch as the citric acid bath can be re-used over and over without replenishment.

The microbeads may be treated prior to inclusion in the ink with a silicate, which may be a dilute aqueous solution of sodium silicate. The beads may also (with or without such sodium silicate treatment) be treated with a silane such as an amino silane prior to inclusion in the ink, and such silane treatment may follow the silicate treatment. A particularly beneficial amino silane is bis-[gamma-(trimethoxysilyl)propyl]amine. These treatments, severally and collectively, appear to enhance the permanence of the attachment of the aluminium coating to the microbeads and of the microbeads to the substrate on printing.

An aminoalkyl silanetriol and/or a blocked polyisocyanate may be added to the liquid carrier medium as coupling agent.

In the event, that a two-pack, rather than a one-pack system is required, an alkoxysilyl alkyl derivative such as an amino silane—which could be the same amino silane used to treat the microbeads—and/or a polyisocyanate (typically where the microbeads are amine treated) may also be added to the liquid carrier medium as coupling agent,

In the preparation of the ink, a liquid carrier medium may be prepared comprising binder chemicals and coupling agent, the microbeads being added to the medium. A pigment may be added to the medium containing the microbeads.

Further additive or additives to be incorporated in the liquid carrier medium, may be selected from the group comprising:
pigment; humectant, optionally urea and/or 2,3 propane diol; buffer, optionally based on ammonium or sodium phosphates; dispersant;
defoamer; thickening agent; cross-linking agent; softening agent; carbon black; UV absorbing material; anti-scuffing agent, optionally a silicone or fluoropolymer; light spill-suppressing agent; anti-static agent and water repellant agent, optionally a silicone or fluoropolymer.

Where a thickener is included, it may be added to the medium in two steps, namely before and after the addition of the binder and coupler.

The microbeads may have silicate (optionally sodium silicate) and/or silane (optionally an amino silane such as bis-[gamma-(trimethoxysilyl)propyl]amino) and/or stannous chloride applied thereto.

The microbeads may be metallised, optionally with a coating of aluminium, the metal being superposed on the stannous chloride.

The microbeads maybe metallised, optionally with a coating of aluminium, the silicate and/or silane being superposed on the metallised beads and the silane where present being superposed on the silicate where present.

Another type of retroreflective ink that may be used in the production of a backdrop in accordance with any of the various aspects of the invention disclosed herein is a retroreflective plastisol ink, especially one which comprises a plastisol containing microbeads treated with a substance that causes them to float in a layer of the plastisol whereby the beads on printing rise to the surface of the printed plastisol layer where they are exposed for retroreflectivity.

To this end, the substance may comprise a fluorosilane and the beads may be treated with an aminosilane.

Retroreflective inks may be made using unmetallised microbeads. Where silvered beads, e.g. beads hemispherically coated with aluminium, are used, the beads may be pretreated prior to metallisation with a metal adhesion enhancer, such, for example, as stannous chloride.

A blocked isocyanate may be added in the plastisol formulation, such, for example, as Trixene BI 7770. The plastisol may comprise polyvinyl chloride (PVC). The ink may contain various additives as referred to hereinbefore, including a thickening agent and/or a surfactant.

The ink, whether plastisol or otherwise based, may comprise 30-70% w/w, e.g. 30-50% w/w, of microbeads and may also contain a pigment, possibly up to 5% w/w of pigment, which may comprise a metallic pigment.

A plastisol-based retroreflective ink may be made by a method comprising treating microbeads with a substance, such as a fluorosilane, that causes them to float in a layer of the plastisol and incorporating the so treated microbeads in the plastisol.

In a particular method, deionised water (6 parts by weight) is added to isopropyl alcohol (114 parts by weight) and the pH adjusted to 5.0±0.5 with acetic acid, fluorosilane (1.1 parts by weight) added and the solution stirred to hydrolyse the silane, and the resulting solution used to treat the microbeads.

The microbeads may be treated with an aminosilane, which may be added (1 part by weight) to the fluorosilane solution after the fluorosilane is hydrolysed and the solution stirred again before being used to treat the microbeads.

60 parts by weight of the solution may be added to 1000 parts by weight of microbeads so as to wet them thoroughly, the solvent then being evaporated off, after which the microbeads may be heated, cooled and sieved.

Metallised microbeads may be pretreated with stannous chloride before metallisation. The treated microbeads may be mixed with a plastisol formulation comprising a base plastisol, a thickening agent, a surfactant and a blocked isocyanate.

The invention also comprises a method for coating or printing a substrate comprising applying a plastisol-based ink as above disclosed to a substrate and curing the applied ink. Where the ink contains a blocked isocyanate, the applied ink is cured at above the unblocking temperature thereof.

Fluorosilane FC 405 manufactured by 3M Corporation and aminosilane Z-6020 manufactured by Dow Corning are suitable for use in the inks.

Blocked isocyanates other than the Trixene BI 7770 may be used, for example Trixene BI 7960 (unblocking temperature 120° C.) and Trixene BI 7960 (90° C.), but the Trixene BI 7770 has an unblocking temperature of 160° C. above which the print must be heated in any event, e.g for two minutes, to ensure adequate fusion of the plastisol.

The beads themselves are desirably 40-60 micron beads in order to pass through conventional printing screens. For optimum reflectivity, the refractive index of the glass should be close to 1.9.

The fluorosilane reaction appears to occur mainly on the uncoated glass surface, causing a greater proportion of the beads than would be expected on random orientation to face in the required direction for retroreflective, namely uncoated side facing outwards.

Without the aminosilane treatment, the fluorosilane treated beads are only poorly held in the PVC matrix and are easily lost on washing. The aminosilane treatment, together with the presence of the blocked isocyanate in the plastisol composition, gives satisfactory washfastness, however.

A substrate provided with a retroreflective coating in accordance with any of the various aspects of the present invention may be provided with an additional coating or coatings for protecting the retroreflective coating against scuffing and/or moisture (i.e. a water repellant coating), e.g. a fluoropolymer coating applied over the retroreflective coating. An anti-static coating may also be applied to the substrate. Alternatively, instead of coating the substrate with such coatings after printing or coating the substrate with retroflective ink, the ink may incorporate ingredients which will confer anti-scuffing, water repellant and/or anti-static properties.

The substrate may be selected from a wide range of materials including textile fabrics (e.g. woven or knitted) such as cotton, polyesters, nylons, silk, wool, viscose and acrylics.

Until recently, chroma-keying involved the use of a coloured backdrop, the electronics behind the system using the backdrop colour as a key (hence the name) to define the area of an imposed image from another filming or from a computer-generated background image. In the chroma-keying technique of GB 2321814 and GB 2321565, a retroreflective backdrop is illuminated by a source of coloured light close to the camera axis. The light is reflected straight back to the camera by retroreflective microbeads, and a very low intensity of light is required, e.g. from a ring of light emitting diodes surrounding the camera lens, which light has negligible effect on the foreground image. This is in contrast to conventional chroma-keying, which requires a high intensity of illumination to provide a sufficient signal from the backdrop to activate the electronic system. Such high intensity illumination is desirably avoided, since it makes a television studio hot to work in and even gives rise to a fire hazard, quite aside from the power cost involved. Moreover, it meant that chroma-keying could really only be carried out in the context of a professional studio.

While this new technique dispenses with the need for very high levels of studio lighting, it relies on the presence of a light source close to the camera, usually provided in the form of a ring of bright light emitting diodes, and this can be expensive and inconvenient.

In further aspects thereof, the present invention provides a method for chroma-keying and a backdrop or backdrop material therefor which do not suffer these disadvantages.

Accordingly, a further aspect of the present invention resides in a method for chroma-keying comprising deploying a coloured backdrop, e.g. a backdrop comprising a coloured material, with retroreflective elements and imaging with a camera a scene against a backdrop with the backdrop principally illuminated with light from a source or sources away from the camera axis.

Thus, for example, the backdrop may comprise a wall surface and/or a plastics or textile material to which a coating comprising retroreflective elements in a polymeric matrix is applied, the elements and/or the polymeric matrix being coloured.

The light used for chroma-keying following reflection and/or scattering from the backdrop, may be derived from incident white light or incident light which is the same colour as the colour of the backdrop.

The backdrop and the scene may also, however, be illuminated with light of the same colour as the backdrop from a source close to the camera axis. In other words, the technique of the patents aforementioned does not have to be totally abandoned; rather, it is optional and can, for instance, be used to sharpen up the image, the important thing being that a chroma-keying signal can be produced without the use of a light source on the camera axis and without the use of high intensity, off-axis lighting.

By and large, the light retroreflected from a substrate in accordance with the present invention will have the same characteristics as the incident light, i.e. if the incident light is coloured, e.g. blue or green, then it is retroreflected as such and if it is white light it will be retroreflected as white light.

The backdrop colour may be blue—the conventional chroma-keying (old technology) colour, or it may be green, green having the advantage that it will readily separate from the background people, e.g. in a news interview, who tend to wear more blue than green. As is made clear in the patents aforementioned, however, any colour can be used as a chroma-keying colour.

The use of retroreflective elements in the material appears to have the effect of intensifying the backdrop colour as seen by the camera, perhaps because they direct light from such illumination sources as are located off the camera axis back towards the sources themselves, leaving only light scattered from the backdrop colourant to reach the camera lens. In any event, with a coloured and retroreflective backdrop or backdrop material, no on-axis light is needed, and very much lower intensities of off-axis lighting are required than would be the case with non-retroreflective material.

The invention also comprises a backdrop substrate for chroma-keying comprising a coloured material with retroreflective elements, the substrate having a smooth surface, in particular a surface such that substantially all of the retroreflective elements, for instance microbeads, are at least to some extent proud of any surface structure of the substrate.

The smooth surfaced material may be a flexible sheet material such as a textile fabric, especially one which is closely woven from continuous filament yarn. This is in contrast with the aforementioned patents where, the surface of the backdrop material was required to be rough, so as to present more of the microbeads to light incident obliquely on the material, with the objective of giving a more even apparent illumination to the backdrop over large areas, for effective chroma-keying. As mentioned previously, the material of the present invention does not need to be rough. Moreover, it is not necessarily required to retroreflect back to the camera since it may have an important role to play in retroreflecting light away from the camera.

It has also been found that chroma-keying can be successfully carried out using retroreflective material as a backdrop in a manner which facilitates auto-cueing. It is a disadvantage of retroreflective chroma-keying that the light source, usually a ring of bright light emitting diodes around the camera lens, precludes the use of an autocue, as it shines straight at the eyes of the person reading same. Autocue systems as used in television studios for example serve to provide a scrolling text which keeps pace with the presentation and shows the portion of the speech currently being given. Autocue systems typically involve projecting text to be displayed onto an angled screen in front of the camera. The angled screen is designed so that the presenter can see the text on the screen whilst at the same time the viewpath of the camera is not obstructed.

Thus, in another aspect of the present invention there is provided a method for chroma-keying comprising deploying a backdrop with retroreflective elements and imaging with a camera a scene against the backdrop with the backdrop illuminated with a chroma-keying light source disposed off the camera axis to an extent which does not impede auto-cueing.

The background and the scene may be illuminated solely by a source or sources separate from the camera. The backdrop may be coloured, the backdrop and the chroma-keying light source optionally being the same colour.

This aspect of the invention may be embodied in a studio installation comprising a backdrop with retroreflective elements, a camera means for imaging a scene against the backdrop, a chroma-keying light source arranged to illuminate the backdrop within the field of view of the camera means, chroma-keying means for processing the image derived by the camera to distinguish subjects viewed from the backdrop, and autocue means provided in the vicinity of the camera means so as to be viewable by a presenter in camera shot from a location forwardly of and along the optical axis of the camera means, the chroma-keying light source being other than coincident or substantially coincident with said optical axis whereby a presenter viewed by the camera means is able to read the autocue means substantially unimpeded by the chroma keying light source.

The chroma-keying light source may for instance be placed up to one metre away from the camera lens (i.e. in laterally offset relation thereto), where it will not interfere with the autocue, and effective chroma-keying is still possible.

The angle subtended, at the backdrop, between the camera axis and the axis of the source of illumination may be within the range of more than 5 degrees up to 45 degrees, preferably 10 to 45 degrees and more preferably 10 to 25 degrees.

In another aspect of the present invention there is provided a studio installation comprising a backdrop or backdrop material as defined herein, camera means positioned for imaging the backdrop and any subjects positioned in front of the backdrop, means for illuminating the backdrop and any such subjects, and chroma-keying means for processing the images derived from the camera means so as to distinguish foreground subjects from the backdrop (or vice versa) by means of light reflected and/or scattered from the backdrop.

The backdrop may be coloured, e.g. green, and the chroma-keying light source may be the same colour as the backdrop.

The installation may include autocue means viewable along the optical axis of the camera means from a foreground position located between the camera location and the backdrop, said illuminating means excluding any source of artificial light projection along an axis substantially coincident with the optical axis of the camera means.

The or each source of artificial light projection constituting the illuminating means is desirably off-axis with respect to the optical axis of the camera means.

The or each source and the camera typically subtends an angle of at least 10 degrees over at least a major portion of the backdrop.

The light used by the chroma-keying means to distinguish foreground subjects from the backdrop preferably originates primarily from sources which are not coincident or substantially co-incident with the optical axis of the camera means.

Usually, in chroma-keying methods as used in television and film sets/studios, a primary objective is to image a subject against a colour-keyed backdrop in such a way that the backdrop can be distinguished from the subject thereby allowing the backdrop area to have an image of a scene for instance to be superimposed thereon so that the subject is seen in the context of the superimposed scene. The present invention in a further aspect thereof is concerned with an alternative application in which the subject is not intended to be distinguished from the backdrop to the same extent as usual, if at all.

According to this further aspect of the present invention there is provided a method of imaging a subject against a backdrop in such a way that the subject is at least in part masked in the image to be viewed, said method comprising deploying a backdrop with retroreflective elements, at least partially covering the subject to be masked with material comprising retroreflective elements, illuminating the backdrop and the subject, imaging with camera means the subject against the backdrop so that light is reflected and/or scattered from the backdrop and the subject to the camera means, and processing the image obtained to produce a viewable image in which the covered part or parts of the subject are substantially indistinguishable from the backdrop.

The subject may be imaged while operating or moving an object or objects which are prominently visible in said viewable image.

This application of the invention is particularly suited to but not limited to the televising or filming of people who are not intended to be seen but actively control what is happening on screen, e.g. entertainers such as puppeteers. For instance, the controlling subject being shot on camera, e.g. the puppeteer, may wear apparel produced from fabric comprising retroreflective material, such as that disclosed herein, so that the controlling subject is masked at least partially and possibly entirely from view in the televised or filmed output while the puppets or other objects being controlled remain visible against an image superimposed on the backdrop and the controlling subject. In other applications, the subject may for special effect be only partially “obliterated” from view.

The viewed image so produced may be such that an image representing a background scene is superimposed on the backdrop and said covered part or parts of the subject so that the background image may appear to be substantially continuous and uninterrupted at the boundaries between the backdrop and the masked part or parts of the subject. The background may be obtained for example by superimposing the desired image same onto the image of the backdrop and the covered parts of the subject, e.g. by electronically superimposing the background image on the image derived by the camera means.

According to yet another aspect of the present invention there is provided a method of imaging an object or objects against a backdrop during manipulation of such object(s) by a manipulating subject or subjects and/or device or devices, said method comprising deploying a backdrop with retroreflective elements, at least partially masking the manipulating subject(s) and/or a device(s) with material comprising retroreflective elements, illuminating the backdrop, the object(s) and said subject(s) and/or device(s), imaging the same while illuminated with camera means against the backdrop so that light is reflected and/or scattered from the backdrop, object(s), subject(s) and/or device(s) to the camera means, and processing the image obtained to produce a viewable image in which the masked part or parts of the manipulating subject(s) and/or device(s) are substantially indistinguishable from the backdrop.

This aspect of the invention is particularly suitable for screening or televising of war gaming, casino games or the like in which objects such as figures and/or models (e.g. soldiers and items of artillery or gambling chips) are moved by hand either directly or with the aid of a suitable device, such as a rake, over a backdrop which can be keyed out by chroma-keying so that in the resulting image, such objects are seen against an appropriate superimposed image. For example, in the case of war gaming, the superimposed image may be that of a battlefield against which regiments of soldiers and artillery are seen whilst, in the case of a casino game, the superimposed image may be that of a roulette table. In such applications, only that part of the controller or a device, e.g. a rake, used by the controller that would otherwise be visible in the screened or televised image is keyed out by masking the same with retroreflective material. Where the controller's hand and arm would otherwise be visible, then such masking may be effected by the wearing of a glove, if necessary with an extended sleeve, fabricated from retroreflective material as disclosed herein.

A library of backdrop stills or videos may be provided so that a variety of images may be superimposed on the background in the production of the resulting image.

The material used as the backdrop material and/or the covering material may be as defined in previously mentioned aspects of the present invention.

Another aspect of the present invention is concerned with a method of producing a retroreflective substrate in which a binder system for adhering microbeads to a porous substrate is applied in a fluid state to a surface of the substrate to form a polymeric matrix or film thereon and in which the binder while in a fluid state on the substrate is forcibly drawn into the substrate.

In this manner, the microbeads may protrude from the polymeric matrix or film to a greater extent than would otherwise be the case. This has been found to give improved retroreflectivity.

The method is typically carried out on a substantially continuous basis with the binder system (with or without microbeads) being applied to the substrate while the latter is in motion. The substrate may be in strip or sheet form and the binder/ink may be supplied to one side of the substrate as it passes beneath a binder or ink applicator station.

This method is particularly advantageous when enhancement of binder curing or drying is employed, e.g. by means of forced air circulation to effect drying and/or the application of heat and/or the inclusion of a catalyst in the binder system to enhance the rate of curing. Unforced air drying under normal ambient conditions requires a relatively long processing time and long process line. However, when attempts were made to speed up processing time and reduce the length of the process line, it was found that retroreflectivity of the end-product suffered. With the above defined method, reduced processing time and a more compact processing line has proved possible without a deleterious affect on retroreflectivity.

The microbeads may be incorporated into the binder system prior to application of the latter to the substrate, e.g. as a one pack ink. Alternatively, they may be subsequently applied to the binder-carrying substrate.

The binder/ink may be forcibly drawn into the substrate material by the application of vacuum (or partial vacuum) to the substrate material, preferably at or in the immediate vicinity of the point of application of the binder/ink to the substrate. The effect of drawing the ink into the substrate may also result in the microbeads being drawn into the structure of the substrate to some extent also, along with the binder, thereby enhancing resistance to abrasion.

The binder/ink may be applied to one face of a substrate in the form of strip or sheet material while the latter is in motion and means such as a doctor blade may be provided for regulating the thickness of the binder/ink coating applied to the substrate. The vacuum may be applied to the other face of the substrate, e.g. at or immediately downstream of the thickness regulating means.

Inks, methods for making them and their use in the production of backdrop materials will now be described by way of example only with reference to the accompanying drawings, in which:

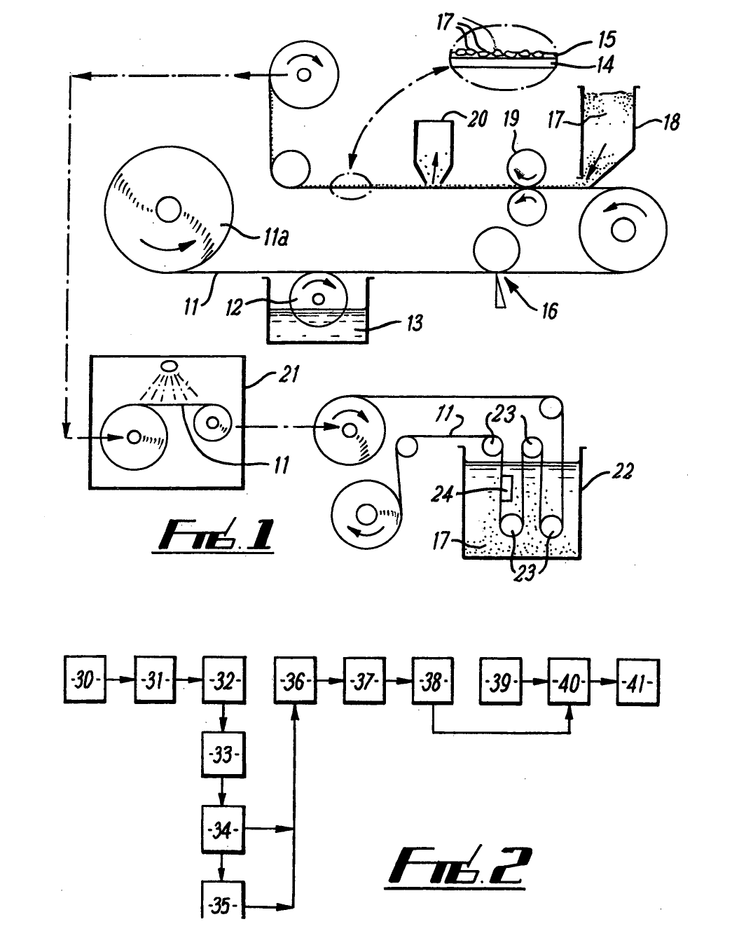

FIG. 1 is a diagrammatic illustration of the production of metallised beads;

FIG. 2 is a block diagram of a process for making an ink;

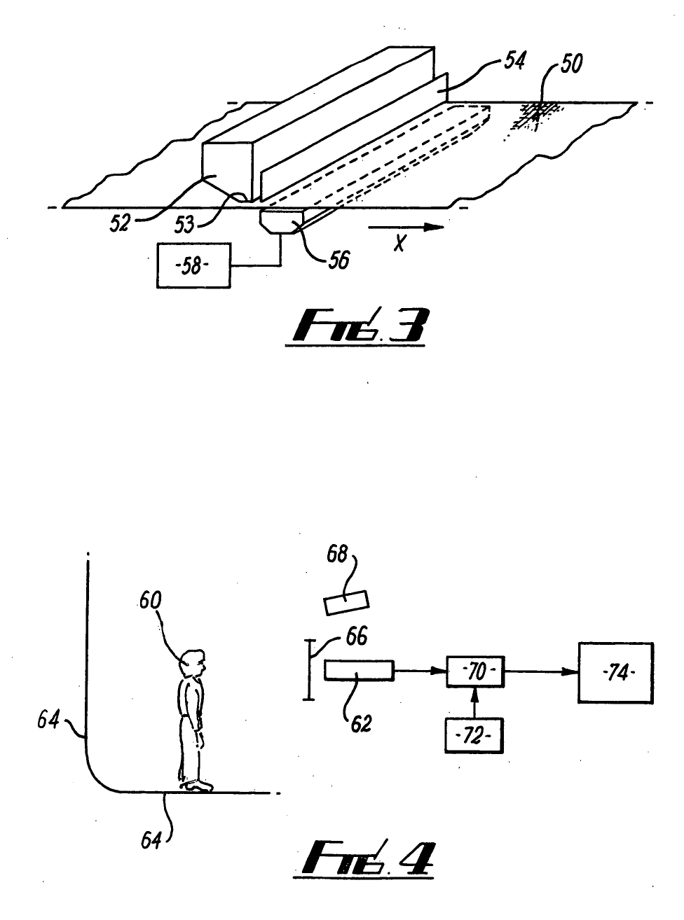

FIG. 3 is a schematic view illustrating the application of a retroreflective ink or a binder system to a moving backdrop substrate; and

FIG. 4 is a schematic view of a television studio or film set in which a subject is imaged using a chroma-keying light source which is off-axis with respect to the camera.

Examples of ink formulations according to the invention are given in the following Tables.

TABLE 1
Inks based on an acrylic copolymer binder system and (3-aminopropyl)
silanetriol coupling agent

| Ingredient/Ink reference | C202 | C205 | C208 |
|---|---|---|---|
| Urea (Humectant) | 10 | 10 | 10 |
| Water | 154 | 179 | 179 |
| Ammonium phosphate buffer | 20 | 20 | 20 |
| Alcoprint PDN (Dispersant) | 2 | 2 | 2 |
| Agitan 218 (Defoamer) | 2 | 2 | 2 |
| Alcoprint PT21 (Thickening agent) | 8 | 8 | 8 |
| 2,3 Propane diol (Humectant) | 25 | 25 | 25 |
| Alcoprint PFL (Trimethoxymethyl | 15 | 15 | 15 |
| melamine cross-linking agent) | | | |
| Alcoprint PSM (Softening agent) | 30 | 30 | 30 |
| Alcoprint PBA (Acrylic copolymer | 300 | 225 | 225 |
| binder) | | | |
| Ammonium hydroxide | 1 | 1 | 1 |
| Silquest VS-142 (3-aminopropyl | 25 | 25 | 25 |
| silanetriol coupling agent) | | | |
| [20% in water] | | | |
| Alcoprint PT21 (Thickening agent) | 6 | 3 | 4.6 |
| Metallised beads (40 micron) treated | 400 | 450 | 400 |
| with sodium silicate and Silquest | | | |
| A-1170 (Bis[trimethoxysilylpropyl] | | | |
| amine) | | | |
| Nonmetallised beads (40 micron) | — | — | 50 |
| treated with sodium silicate and | | | |
| Silquest A-1170 | | | |
| Total | 997 | 995 | 996.6 |
| Binder volume % | 12 | 9 | 9 |
| Bead volume % | 16 | 18 | 18 |
| Binder volume/bead volume % | 75 | 50 | 50 |
| Viscosity | 20.7 | 16.2 | 23.2 |
| Temperature | 16.6 | 16.6 | 16.6 |
| pH | 8.4 | 8.9 | 8.8 |

TABLE 2
Inks based on a polyvinylidene chloride copolymer binder system and
(3-aminopropyl) silanetriol coupling agent

| Ingredient/Ink reference | V246 | V248 | V251 |
|---|---|---|---|
| Urea (Humectant) | 10 | 10 | 10 |
| Water | 128 | 288 | 288 |
| Ammonium phosphate buffer | 20 | 20 | 20 |
| Emulsifier WN (Dispersant) | 3 | 3 | 3 |
| Agitan 218 (Defoamer) | 2 | 2 | 2 |
| Alcoprint PT21 (Thickening agent) | 8 | 8 | 8 |
| 2,3 Propane diol (Humectant) | 25 | 25 | 25 |
| Polidene 33-048 (Binder) | 273 | 163 | 163 |
| Ammonium hydroxide | 1.4 | 1.4 | 1.4 |
| Silquest VS-142 (Coupling agent) | 25 | 25 | 25 |
| [20% in water] | | | |
| Alcoprint PT21 (Thickening agent) | 3 | 5 | 3 |
| Metallised beads (40 micron) treated | 500 | 450 | 400 |
| with sodium silicate and Silquest | | | |
| A-1170 | | | |
| Non-metallised beads (40 micron) | — | — | 50 |
| treated with sodium silicate and | | | |
| Silquest A-1170 | | | |
| Total Weight of Ink (g) | 998.4 | 1,000.4 | 998.4 |
| Binder volume % | 15 | 9 | 9 |
| Bead volume % | 20 | 18 | 18 |
| Binder volume/bead volume % | 75 | 50 | 50 |
| Viscosity (pascals) | 25.6 | 14.2 | 12.3 |
| Temperature (° C.) | 17.7 | 17.6 | 17.2 |
| pH | 8.6 | 8.7 | 8.7 |

TABLE 3
Inks based on a polyvinylidene copolymer binder system and a
combination of (3-aminopropyl) silanetriol and blocked hexamethylene
diisocyanate trimer coupling agents

| Ingredient/Ink reference | V253 | V254 | V257 | VA6000 |
|---|---|---|---|---|
| Urea (Humectant) | 10 | 10 | 10 | 10 |
| Water | 91 | 183 | 183 | 72 |
| Ammonium phosphate buffer | 20 | 20 | 20 | 20 |
| Emulsifier WN (Dispersant) | 2 | 2 | 2 | 2 |
| Emulsifier HVN (Dispersant) | 2 | 2 | 2 | 2 |
| Agitan 218 (Defoamer) | 2 | 2 | 2 | 2 |
| Alcoprint PT21 (Thickening agent) | 9.3 | 8 | 8 | 8 |
| 2,3 Propane diol (Humectant) | 25 | 25 | 25 | — |
| Polidene 33-048 (Binder) | 273 | 181 | 181 | 218 |
| Ammonium hydroxide | 1.4 | 1.4 | 1.4 | 1.4 |
| Silquest VS-142 (Coupling agent) | 25 | 25 | 25 | 25 |
| [20% in water] | | | | |
| Trixene BI 7986 (Coupling agent) | 40 | 40 | 40 | 40 |
| Alcoprint PT21 (Thickening agent) | — | — | — | — |
| Metallised beads (40 micron) treated | 500 | 500 | 400 | 600 |
| with sodium silicate and Silquest | | | | |
| A-1170 | | | | |
| Non-metallised beads treated with | — | — | 100 | — |
| sodium silicate and Silquest A-1170 | | | | |
| Total Weight of Ink (g) | 1,000.7 | 999.4 | 999.4 | 1000.4 |
| Binder Volume % | 15 | 10 | 10 | 12 |
| Bead Volume % | 20 | 20 | 20 | 24 |
| Binder Volume/Bead Volume | 75 | 50 | 50 | 50 |
| Ratio % | | | | |
| Viscosity (pascals) | 22.5 | 22.1 | 21.2 | — |
| Temperature (° C.) | 19.3 | 19.0 | 19.0 | — |
| pH | 8.4 | 8.3 | 8.4 | — |

TABLE 4
Inks based on a polyurethane binder system and a blocked 1,6
Hexamethylene diisocyanate trimer coupling agent

| Ingredient/Ink reference | P96 | P98 | P102 |
|---|---|---|---|
| Urea (Humectant) | 10 | 10 | 10 |
| Water | 62 | 187 | 187 |
| Sodium Phosphate Buffer | 10 | 10 | 10 |
| Emulsifier WN (Dispersant) | 3 | 3 | 3 |
| Agitan 218 (Defoamer) | 2 | 2 | 2 |
| Alcoprint PT21 (Thickener) | 3.0 | 3.1 | 3.0 |
| 2,3 Propane diol (Humectant) | 25 | 25 | 25.1 |
| Alcoprint PSM (Softener) | 30 | 30 | 30 |
| Witcobond 769 (Binder) | 300 | 225 | 226 |
| Trixene BI-7986 (Coupler) | 50 | 50 | 50 |
| Alcoprint PT21 (Thickener) | 0.7 | 4.0 | 3.0 |
| Metallised beads treated with | 500 | 450 | 400 |
| sod.silicate and Silquest A-1170 | | | |
| Non-metallised beads treated with | — | — | 70 |
| sod.silicate and Silquest A-1170 | | | |
| Total Weight of Ink (g) | 993.7 | 999.1 | 1,019.1 |
| Binder Volume % | 12 | 9 | 8.8 |
| Bead Volume % | 60 | 18 | 18.5 |
| Binder Volume/Bead Volume | 60 | 50 | 47.9 |
| Ratio % | | | |
| Viscosity (pascals) | O/R | 31.0 | 32.0 |
| Temperature (° C.) | 18.8 | 18.2 | 18.5 |

Generally speaking, the ingredients are added in the tabulated order given in Tables 1 to 4. The thickener is added in two stages. Pigment, not tabulated, is added at the end in suitable quantity to yield the desired colour.

Viscosities were measured with a Brookfield viscometer using a number 5 spindle rotating at 10 rpm.

Table 5 lists the chemical nature and sources of proprietary products used in the inks of Tables 1 to 4.

TABLE 5

| | Proprietary | | |
|---|---|---|---|
| Ink Component | Product | Chemical Nature | Supplier |
| Binder | Alcoprint PBA | Aqueous emulsion of an | Allied Colloids |
| | | acrylic copolymer | |
| | Polidene 33-048 | Aqueous emulsion of a | Scott Bader |
| | | vinylidene chloride/ | |
| | | acrylate copolymer | |
| | Witcobond 769 | Water based polyurethane | Baxenden |
| | | dispersion | |
| Cross-linking/ | Alcoprint PFL | Trimethoxymethyl | Allied Colloids |
| coupling agent | | melamine | |
| | Silquest VS-142 | 3-Aminopropyl | OSi Specialities/ |
| | | silanetriol | Ambersil Ltd. |
| | Silquest A-1170 | bis-trimethoxysilylpropyl) | OSi Specialities/ |
| | | amine | Ambersil Ltd. |
| | Trixene BI-7986 | Blocked 1,6 hexamethylene | Baxenden |
| | | diisocyanate trimer | |
| Softening agent | Alcoprint PSM | | Allied Colloids |
| Thickening agent | Alcoprint PT21 | Dispersion of an acrylic | Allied Colloids |
| | | copolymer in light | |
| | | mineral oil | |
| Dispersant | Alcoprint PDN | Aqueous solution of an | Allied Colloids |
| | | anionic acrylic polymer | |
| | Emulsifier WN | Nonionic arylpolyglycol ether | Bayer |
| | Emulsifier HVN | | BASF |
| Defoaming agent | Agitan 218 | | Munzing |
| Chemie | | | |

Retroreflective microbeads may be made by a process which is generally similar to the one that has been used commercially for many years, namely by embedding glass microspheres in an adhesive layer on a substrate and coating the exposed surface of the microspheres with an aluminium layer in a vacuum metalliser. There are, however, subtle, but important differences. The method according to the invention, which is novel and inventive per se for the manufacture of hemispherically coated microbeads, regardless of any ink formulation in which they will be used is illustrated by way of example in FIG. 1.

A carrier material 11, which is for example a polyester film, supplied on a reel 11a, which may contain, say, 1000 m of film of width 1500 mm, is coated by contact with a lick roller 12 dipping into a bath 13 with an 18 micron layer 14 of a styrene/butadiene type adhesive 15, the coating thickness being determined e.g. by a doctor blade/roller arrangement 16.

Beads 17 (see inset to FIG. 1) are scattered on the adhesive layer 14 from a hopper 18 and pressed into the adhesive layer 14 by a roller arrangement 19. Excess beads are removed e.g. by suction arrangement 20.

Glass beads of refractive index 1.9, size 40 microns are used, and, after the roller arrangement 19, appear, in cross-section, as shown in the inset.

The beaded carrier material 11 is then passed through a vacuum metalliser 21 to be coated with aluminium to a thickness of about 300 Angstrom Units. The material 11, wound on a reel, is placed in the vacuum metalliser and run off on to a take-up reel to which it is secured; then the metalliser is evacuated and the aluminium source energised and the material passed reel-to-reel to expose it to the aluminium vapour. The coated, beaded carrier 11 is then passed through a bath 22 of aqueous solution (1%) of citric acid at a temperature of 40-50° C., passing over a series of rollers 23 to provide a dwell time in the bath of several minutes. The material 11 also passes over an ultrasonic plate 24 which aids release of the microbeads which fall to the bottom of the bath 22. At the end of the run of 1000 m of carrier 11, the microbeads are sucked out of the bottom of the bath 22, rinsed with water and dried.

The effect of the citric acid bath is to cause the styrene/butadiene adhesive to lose its tack and release the microbeads. The material 11 regains its tack on drying, and can be re-used for further runs of bead manufacture without the need for further coating. The citric acid bath 22 can likewise be reused without replenishment of the citric acid.

Prior to coating, the glass beads are pre-treated with a dilute aqueous solution of stannous chloride, followed by drying and resieving. It is found that this gives significant improvement in the durability of the reflectivity of a printed design.

After coating, the beads are treated with a dilute aqueous solution of sodium silicate. It is thought that the treatment passivates the aluminium coating, reducing its susceptibility to attack in aqueous environments, while, at the same time, the sodium silicate reacts with the titanium/barium glass and/or the aluminium increasing the number of reactive sites on the surface of the coated microbeads that are available for reaction with the coupling agent in the ink.

If this sodium silicate treatment is carried out close to the metallisation process, the beads from that process can be used after rinsing but before drying. About 40 kg wet metallised beads (containing some 10 kg water) are mixed with a solution of 20 kg water containing 1.4 kg sodium silicate and stirred for 5 minutes. The beads are then allowed to settle, the sodium silicate solution decanted off, the beads rinsed with tap water, with a final rinse in deionised water.

Significant improvement in washfastness, especially with low (e.g. below 0.5%) levels of certain coupling agents in the formulation (which considerably improves shelf life), is obtained by further treatment of the metallised beads with amino silanes, significantly bis-[gamma-(trimethoxysilyl)propyl]amine.

The combined effect of these bead preparation treatments is to provide an ink with a shelf life well in excess of 12 months yet which exhibits insignificant loss of retroreflectivity after multiple washings at 40° C., even if the amount of coupling agent is as low as 0.5%.

FIG. 2 is a block diagram of production steps for a typical ink according to the invention, the steps being:
30 Glass microbead production, with any necessary sieving to a desired size range—about 40 microns is an ideal size;
31 Stannous chloride pre-treatment, drying;
32 Metallising;
33 Recovery in citric acid solution;
34 Rinsing;
35 Drying;
36 Sodium silicate treatment of metallised beads;
37 Rinsing;
38 Amino silane pre-treatment;
39 Mixing liquid carrier medium;
40 Add treated metallised (and, if desired, unmetallised) beads to carrier medium;
41 Add pigment;

Ink formulations detailed herein, formulated by the methods described, operating as one-pack systems, have long shelf lives, being usable after more than six months, in many cases after more than a year after formulation (based on accelerated ageing measurements at elevated storage temperatures). They show higher initial retroreflectivties at the lower binder/bead volume ratios made possible by the various measures described.

Washfastness and abrasion resistance are acceptable with binder volumes as low as 9%—reducing binder content in the formulation containing polyvinylidene chloride and Trixene actually increases abrasion resistance.

The various novel ingredients and combinations of ingredients each have their contributions to make in connection with the production of one pack inks and while the importance of a binder combined with a coupling agent reacting only at elevated temperature has been particularly noted, it is not intended to suggest that that might be the only novel and inventive subject matter disclosed herein. The pre-treatment of the beads both before and after metallisation also has profound effects even with the binder/coupler systems and is of advantage also in the preparation of inks for printing on substrates which will not withstand elevated temperatures. Here it is necessary to resort to a two-pack system, with the coupling agent mixed into the ink just before printing. A reactive polyisocyanate may be used as a coupling agent in such circumstances. A two-pack arrangement is, of course, more convenient to use than the old three-pack system, and is made possible by bead pre-treatment.

Where unmetallised beads are added—giving the effect, quite obviously, of reducing overall retroreflectivity, but reducing the greyness associated with metallised beads and therefore enhancing the colour brightness of pigmented inks, the unmetallised beads also benefit from the bead pre-treatment, particularly treatment with silicate and silane.

Unmetallised beads may also be used in similar formulation, and having had similar pre-treatment, without metallised beads but with flake particles having a mirror-like finish. Such a coating composition, said to be suitable for application by brushing, was described in U.S. Pat. No. 3,835,087, Searight et al, issued 10 Sep. 1974, and printing ink of this description is commercially available.

The present invention also contemplates the use of one-pack inks containing unmetallised glass microspheres and flake particles, an ink comprising a liquid carrier medium including binder chemicals for attaching the microbeads and flake particles to a substrate to which the ink is to be applied and a coupling agent which couples the microbeads and cross-links the binder chemicals, characterised in that the coupling agent is unreactive except at elevated temperature at which the ink of the substrate is cured.

Binder and coupler systems as described above are suitable, and the microbeads benefit in the same way from the sodium silicate and amino silane pre-treatment—the stannous chloride pre-treatment is unnecessary.

A preferred flake material is Iriodin 123—mica flake coated with titanium dioxide, supplied by Merck. The optimum particle size is 5-35 microns, and the flake may be present in an amount about 7.5% by weight.

Mean glass microbead size may be 60 micron—larger beads, e.g. up to 70 micron and larger may be used but may not be suitable for finer screen printing mesh sizes. Good quality, e.g. 1.9 refractive index, beads give better results than lower refractive index beads, and best results are obtained using 60 micron TSTF (twice sieved twice fired) beads.

Coloured reflectivity can be achieved by using interference pigments (Iriodin 200 series), while gold lustre mica pigments (Iriodin 300 series) and metal lustre pigments (Iriodin 500 series) give interesting effects particularly when printed on coloured fabrics.

Table 6 lists ingredients for a range of such inks.

TABLE 6

| Ingredient/Ink reference | NMB155 | NMB182 | NMB185 | NMB191 |
|---|---|---|---|---|
| Urea (Humecant) | 10 | 10 | 10 | 10 |
| Water | 79 | 134 | 94 | 91 |
| Ammonium phosphate buffer | 20 | 20 | 20 | — |
| Sodium phosphate buffer | — | — | — | 10 |
| Emulsifier WN (Dispersant) | — | 3 | 2 | 3 |
| Emulsifier HVN (Dispersant) | — | — | 2 | — |
| Alcoprint PDN (Dispersant) | 2 | — | — | — |
| Agitan 218 (Defoamer) | 2 | 2 | 2 | 2 |
| Alcoprint PSM (Softener) | 30 | — | — | 30 |
| Alcopriny PT21 (Thickener) | 4 | 4.8 | 3.3 | 3 |
| 2,3 Propane diol (Humectant) | 25 | 25 | 25 | 25 |
| Alcoprint PFL (Cross-linker) | 15 | — | — | — |
| Alcoprint PBA (Binder) | 300 | — | — | — |
| [acrylic] | | | | |
| Polidene 33-048 (Binder) | — | 300 | 300 | — |
| [polyvinylidene chloride] | | | | |
| Witcobond 769 (Binder) [polyurethane] | — | — | — | 300 |
| Trixene BI-7986 (Coupling agent) | — | — | 40 | 50 |
| Ammonium hydroxide | 1 | 1.4 | 1.4 | — |
| Silquest VS-142 (Coupling | 25 | 25 | 25 | — |
| agent) [20% in water] | | | | |
| Alcoprint PT21 (Thickener) | 3.5 | — | — | 1 |
| Iriodin 123 [Mica coated with | 75 | 75 | 75 | 75 |
| titanium dixoide] | | | | |
| Beads (60 micron) treated with | 400 | 400 | 400 | 400 |
| sod.sil.+ A-1170 | | | | |
| Total weight (g) | 991.5 | 1000.2 | 999.7 | 1000.0 |
| Viscosity (pascals) | 23.6 | | | |
| pH | 8.5 | | | |

As previously mentioned, the retroreflective ink may be a plastisol-based ink and the beads may be treated with fluorosilane and aminosilane. A typical Example will now be described.

Silane treatment solution preparation: Deionised water (6 g) is added to isopropyl alcohol (114 g) and the pH adjusted to 5.0±0.5 with acetic acid. Fluorosilane FC 405 (1.1 g) is added and the solution stirred for 5-15 minutes to hydrolyse the silane. The aminosilane Z-6020 (1.0 g) is added and the solution stirred for a further 30 minutes.

Bead Treatment: To 1 kg of metallised beads (pretreated with stannous chloride before metallising to improve adhesion of the 0.03 micron thick aluminium layer) is added 60 g of the isopropyl alcohol solution ensuring that the beads are completely wetted. The solvent is evaporated off, and the beads heated for 1 hour at 120° C. The treated beads are finally cooled and sieved.

Base Plastisol Formulation

| | |
|---|---|
| PVC powder | 600 g |
| Plasticiser | 450 g |
| Cd/Zn Stabiliser | 12 g |

Plastisol Ink Formulation

| | % w/w |
|---|---|
| Base plastisol | 53.24 |
| Thickening agent | 0.16 |
| Surfactant | 0.60 |
| Blocked isocyanate | 6.00 |
| Fluorosilane/amino-silyated | 40.00 |
| metallised beads | |

Coloured prints can be obtained by including plastisol compatible pigments; loss of reflectivity is minimal with pigment levels below about 5% w/w. Metallic pigments can be used to produce attractive visual effects.

In general, the suitability of any given fabric for use as a retroreflective studio background can be readily determined by printing or coating a sample with the particular retroreflective material employed (whether aqueous-based, plastisol-based or otherwise) and making the appropriate measurements. It is not at this time possible to predict precisely the performance of a fabric, though further development may enable this to be done from surface parameters.

Of importance also is the fact that it may not always be required to have a perfectly retro-reflective surface (or one as perfectly retro-reflective as possible). Combining the inks with different surfaces can produce, for example, a bright screen for projection in which light incident from a projector is reflected back over an angular extent corresponding to a viewing seating plan. The inks can indeed be applied to any surface, e.g. to a plaster wall, wood or metal surface, or to paper, to make an inexpensive viewing screen.

In one application, an outdoor viewing screen can comprise a lattice e.g. of polyvinyl chloride, say 10 m×12 m in size, the lattice being waterproof but air permeable so as to be stable even in windy conditions. This is an example where the high resolution required for broadcast standard imaging (including chroma-keying) may be replaced by a lower resolution.

Less-than-perfectly retroreflective backdrops, screen and other surfaces may be used in connection with domestic, or undemanding commercial video. The inks, however, may be of the same specification, the difference being in the choice of surface or substrate.

The inks may, of course, be applied in any convenient manner. They can be printed using conventional screen or other printing techniques (the microbeads can be made small enough to pass through fine mesh screens), sprayed, coated and painted by brush or roller, for example.

It has been found to be particularly advantageous if the ink, prior to curing or drying thereof, is caused to be drawn into the substrate, for instance by suction, so that the microbeads protrude from the resulting polymeric matrix to a greater extent than would otherwise be the case. Accordingly, the substrate may have some degree of porosity so as to allow a vacuum, or partial vacuum, to be applied and thereby draw the binder into the structure of the substrate, e.g. into the valleys in the case of a woven or knitted fabric. Improved retroreflectivity has been observed in backdrop substrates produced in this manner, with the advantage that the quantity of microbeads employed in order to secure a given degree of retroreflectivity may be reduced with consequent cost savings. The (partial) vacuum is conveniently applied in the immediate vicinity of the point of application of the ink. For instance, where the ink is coated onto a moving substrate in the form of a strip or sheet of porous material, the (partial) vacuum may be applied at or immediately downstream of the point of coating, the vacuum being drawn at that location by a suction chamber located beneath the moving substrate material. The suction chamber may be of elongate configuration in a direction transverse to the direction of travel of the moving substrate.

Thus, referring purely by way of example to FIG. 3, a moving substrate 50 of porous strip or sheet material (e.g. a woven or knitted fabric) passes beneath a reservoir 52 of retroreflective ink which is deposited onto the substrate via a slot 53 which extends tranversely of the direction of travel X of the substrate so as to coat the moving strip or sheet across substantially its full width. The thickness of the applied coating is regulated by suitable means, e.g. a doctor blade 54, immediately downstream of the applicator slot 53. A vacuum chamber 56 connected to vacuum pump 58 is located beneath the substrate immediately downstream of the doctor blade 54 so that a vacuum may be applied to the substrate at this location while the applied coating is still in a substantially uncuried or undried state. In this way, the fluid component is caused to penetrate into the structure of the porous substrate material to a greater extent than the microbead content thereof whereby the microbeads tend to protrude above the polymeric matrix or film so formed following curing/drying of the coating than would otherwise be the case.

As mentioned, the inks may be fire or flame retardant and may be applied to fire or flame retardant substrates, which is of importance in domestic and commercial situations as well as in broadcast and professional video and film studios.

While one-pack inks have been particularly referred to, it would, of course, be possible to provide ingredients separately, e.g. binder, beads and pigment, so that an appropriate bead size and pigment colour could be selected at time of use. There are, however, clear advantages to be had from a one-pack system inasmuch as control over the manufacture will ensure a constant quality level, not to mention the trouble saved in mixing. The various treatments involved, however, in connection with the one-pack formulation render the inks suitable for all the purposes described herein, notwithstanding that the ink, for whatever reason, might be presented as a two or three pack system.

Instead of coating a backdrop substrate, such as a drapeable fabric or a wall surface, with an ink as described above, in alternative embodiments of the invention, the retroreflective component may be applied to the backdrop substrate by initially coating the substrate with a binder system and then applying the retroreflective elements, e.g. metallised microspheres, to the coating of binder so that the elements adhere thereto. Another variation comprises applying, e.g. by painting or spraying, a layer of reflective material, such as aluminium or silver, to the substrate and then applying binder and microbeads over such reflective layer. In this latter case, the binder may incorporate the microbeads or the microbeads may be applied subsequently, e.g. by scattering, on to the binder layer and the microbeads need not necessarily be treated to render them retroreflective, e.g. a proportion ranging from 0 to 100% of the microbeads may be retroreflective and the remainder may be plain.

Another alternative is to coat the substrate with a binder system which incoporates retroreflective elements, for example in the form of retroreflective flake particles such as mica flakes, and then apply glass microspheres to the binder coating, which microspheres need not necessarily be treated to impart retroreflectivity thereto. For instance, the microspheres may be beads of glass without any hemispherical metallised coating. In these alternative approaches, the binder system may be allowed to become tacky before the microspheres are applied to the binder coating.

In such alternative methods, the binder system may incorporate a colouring agent such as a pigment to impart a desired colour to the backdrop for chroma-keying purposes. The microspheres applied subsequently to the binder coating may be scattered onto the coating so as to embed into the coating and adhere thereto.

Where a coloured backdrop is required in such alternative methods or where a retroreflective ink as previously described is used, we do not exclude the possibility of colouring the backdrop substrate initially (or using a backdrop substrate which is already coloured) and employing an ink or binder system which is sufficiently transparent to allow the backdrop colour to show through.

Where the binder system is applied to the substrate material prior to application of the microbeads (whether retroreflective or not), the binder system may be applied in the manner described above (e.g. in relation to FIG. 3) so that the binder is caused to penetrate into the substrate material. The microbeads may then be applied while the binder is still tacky.

A typical application of a retroreflective backdrop produced in accordance with the present invention is illustrated in FIG. 4 in which a presenter 60 is imaged by a camera 62 against a retroreflective backdrop 64 which extends both generally vertically and generally horizontally. An autocue or teleprompter device 66 is located forwardly of the presenter and is arranged to scroll text to be read out by the presenter while looking straight into the camera. The presenter 60 and the backdrop 64 are generally illuminated by sources of light (not shown) and a chroma-keying light source 68 which may comprise one or more LEDs emitting blue or green light for example. As mentioned previously, if the backdrop is illuminated by means of paraxial array of LEDs as described in GB Patent No. 2321565, the presenter's ability to read the autocue may be seriously impaired. In contrast with GB Patent No. 2321565, the chroma-keying light source 68 is located away from the optical axis of the camera. The backdrop 64 may be coloured, as described previously, and its colour may be the same as that emitted by the chroma-keying source 68, e.g. blue or green.

The video output of the camera 62 is supplied to a chroma-key unit 70 which identifies the subject based on the colour of the image and overlays a separate background image from a source 72 on to the background portions of the image to produce a composite image which may be displayed on a monitor 74 whereby the subject 60 is seen against the background image supplied from source 72. It has been found that, even if the chroma-keying light source 68 is located away from the camera axis as illustrated, it is possible to obtain sufficient chroma-keying light by retroreflection (particularly when using the backdrop materials of the present invention) to secure the desired keying out of the background. In this way, the subject's ability to read the autocue 66 is not impeded by a source of chroma-keying illumination which is substantially coincident with the optical axis of the camera 70.

1. A retroreflective studio background or backdrop material to which is applied an ink comprising retroreflective elements in a polymeric matrix, the ink being one which comprises comprises retroreflective elements and microbeads additional to said retroreflective elements, binder chemicals for attaching the retroreflective elements and microbeads to a substrate to which the ink is applied and a coupling agent for coupling the microbeads and cross-links the binder chemicals, the coupling agent being unreactive until the ink application process is carried out.

2. A background or backdrop material according to claim 1 wherein the ink comprises retroreflective elements and microbeads prior to application to the substrate.

3. A background or backdrop material as claimed in claim 1 wherein the binder forms at least part of a liquid carrier medium in which the retroreflective elements and microbeads are incorporated.

4. A background or backdrop material as claimed in claim 1 wherein the binder chemicals, coupling agent and retroreflective elements and microbeads comprise a one pack retroreflective ink.

5. A background or backdrop material as claimed in claim 1 wherein the binder chemicals and retroreflective elements and microbeads comprise the first pack of a two-pack retroreflective ink with the coupling agent comprising the second pack and the coupling agent comprises a reactive polyisocyanate and/or an alkoxysilyl alkyl derivative.

6. A background or backdrop material according to claim 1 wherein the retroreflective elements and microbeads are applied to the substrate after the application of the binder to the substrate.

7. A background or backdrop according to claim 1 which has a retroreflectivity that remains substantially uniform from normal (0°) to high (60°) angles of incidence.

8. A background or backdrop material as claimed in claim 1 wherein the normalised retroreflectivity is maintained to such as an extent that it is at least about ¼, preferably at least about ⅓ and more preferably at least about ½, at an angle of incidence of at least 60 degrees to normal.

9. A background or backdrop material according to claim 1 wherein the retroreflective elements are retroflectively coated microbeads and the proportion of microbeads which do not have a retroreflective coating constitutes no more than 50% of the total microbead content.

10. A background or backdrop material as claimed in claim 1 wherein the ink is applied by printing or coating on to a background fabric material constituting the backdrop.

11. A background or backdrop material as claimed in claim 1 wherein the substrate comprises a woven fabric having warp and weft crowns or a knitted fabric having a stitch structure.

12. A background or backdrop material as claimed in claim 1 wherein the surface structure of the substrate is smooth such that substantially all of the retroreflective elements are at least to some extent proud of the surface structure of the fabric.

13. A background or backdrop material as claimed in claim 1 wherein it is printed or coated in solid colour for chroma-keying.

14. A background or backdrop material as claimed in claim 1 wherein it is printed in a pattern or design, optionally in different colours of retroreflective ink, or printed or coated in a single colour of retroreflective ink and overprinted with a pattern or design.

15. A background or backdrop material as claimed in claim 1 wherein it is fire or flame retardant.

16. A background or backdrop material as claimed in claim 1 wherein the backdrop comprises a fireproof or fire retardant fabric to which said retroreflective ink is applied, the fabric comprising a structural component that chars before it melts.

17. A background or backdrop material as claimed claim 1 wherein the backdrop comprises a fireproof or fire retardant fabric to which said retroreflective ink is applied, the fabric comprising a structural component that chars before it melts wherein the fire retardant agent comprises Proban® or Pyrovatex® or a like agent, applied to a cellulosic.

18. A background or backdrop material as claimed in claim 1 wherein it is made fireproof or fire retardant by application of a fire retardant agent.

19. A background or backdrop material as claimed in claim 1 wherein the fabric comprises an aramid fibre.

20. A background or backdrop material as claimed in claim 1 wherein the ink is non-burning once applied to the background or backdrop material, the ink is an aqueous-based ink and the polymeric matrix comprises polyvinylidene chloride.

21. A background or backdrop material as claimed in claim 1 wherein the polymeric matrix comprises polyvinyl chloride or other non-flammable plastisol.

22. A background or backdrop material as claimed in claim 1 wherein the coupling agent is unreactive except at elevated temperature at which the ink is cured.

23. A background or backdrop material as claimed in claim 1 wherein the binder/coupling agent system is selected from the group comprising:
polyvinylidene chloride copolymer as binder and (3-aminopropyl) silanetriol and/or blocked 1,6 hexamethylene diisocyanate trimer as coupling agent;
an acrylic copolymer as binder and (3-aminopropyl) silanetriol and/or blocked 1,6 hexamethylene diisocyanate trimer as coupling agent; and
polyurethane as binder and blocked 1,6 hexamethylene diisocyanate trimer as coupling agent.

24. A background or backdrop material as claimed in claim 1 wherein it further comprises one or more components selected from the group comprising:
pigment; humectant, optionally urea and/or 2,3 propane diol;
buffer, optionally based on ammonium or sodium phosphates;
dispersant; defoamer; thickening agent; cross-linking agent;
softening agent; carbon black; UV absorbing material; anti-scuffing agent, optionally a silicone or fluoropolymer, light spill-suppressing agent; anti-static agent and water repellant agent, optionally a silicone or fluoropolymer.

25. A background or backdrop material as claimed in claim 1 wherein the binder volume to bead volume ratio is equal to or less than 50%.

26. A background or backdrop material as claimed in any claim 1 wherein the microbeads are all or essentially all unmetallised and the retroreflective elements comprise reflective flake particles.

27. A background or backdrop material as claimed in claim 1 wherein the ink incorporates metalised or unmetalised microbeads having silicate (optionally sodium silicate) and/or silane (optionally an amino silane such as bis-[gamma-(trimethoxysilyl)propyl]amino) and/or stannous chloride applied thereto.

28. A background or backdrop material as claimed in claim 1 in which the microbeads have stannous chloride applied to them wherein the retroreflective elements comprise metalised microbeads which are metallised with a coating of aluminium superposed on the stannous chloride.

29. A background or backdrop material as claimed in claim 1 wherein the retroreflective elements comprise metallised microbeads which are metallised with a coating of aluminium, a silicate and/or silane is superposed on the metallised beads and a silane where present is superposed on the silicate where present.

30. A background or backdrop material as claimed in claim 1 wherein the microbeads have one or more of the following characteristics: a refractive index in the range of 1.8 to 2.2, preferably about 1.9; a median size in the range of 10 to 100 microns, preferably 25 to 70 microns; and composed of titanium/barium glass.

31. A background or backdrop material as claimed claim 1 wherein the ink is water-based.

32. A background or backdrop material as claimed in claim 1 wherein the ink is formulated suitably for screen printing and optionally has a viscosity less than or equal to 40 pascals, preferably between 10 and 30 pascals, at room temperature.

33. A method for producing a background or backdrop material according to claim 1 in which the ink comprises retroreflective elements and microbeads prior to application to the substrate, comprising the steps of:
making microbeads;
suspending microbeads and reflective elements in a liquid carrier medium comprising binder chemicals for attaching the microbeads to the substrate to which the ink is to be applied and a coupling agent which couples the microbeads and cross-links the binder chemicals, the coupling agent being unreactive except at elevated temperature at which the ink-carrying substrate is cured,
applying, the liquid carrier medium on to said substrate, and
causing or allowing the coupling agent to react during and/or after said ink application step.

34. A method as claimed in claim 33 comprising the additional step of applying an aluminium coating to microbeads so as to form reflective elements.

35. A method as claimed in claim 33 comprising the additional step of pre-treating the microbeads with stannous chloride prior to application of the aluminium coating.

36. A method as claimed in to claim 33 in which the microbeads are treated with a dilute aqueous solution of stannous chloride.

37. A method as claimed in claim 33 comprising the additional step of treating the microbeads prior to inclusion in the liquid carrier medium with a silicate, optionally a dilute aqueous solution of sodium silicate.

38. A method as claimed in claim 33 comprising the additional step of treating the microbeads with a silane, preferably an amino silane, prior to inclusion in the liquid carrier medium.

39. A method as claimed in claim 33 in which the microbeads are treated with the silane, optionally an amino silane such as bis-[gamma-(trimethoxysilyl)propyl]amine, following a silicate treatment.

40. A method as claimed in claim 33 comprising the additional step of adding an amino silane, e.g. an amino silane, and/or a blocked polyisocyanate to the liquid carrier medium as coupling agent.

41. A method as claimed in claim 33 in which a liquid carrier medium is prepared comprising binder chemicals and coupling agent, and the microbeads are added to the medium.

42. A method as claimed in claim 33 in which a further additive or additives are incorporated in the liquid carrier medium, said additives being selected from the group comprising:
pigment; humectant, optionally urea and/or 2,3 propane diol;
buffer, optionally based on ammonium or sodium phosphates;
dispersant; defoamer; thickening agent; cross-linking agent;
softening agent; carbon black; UV absorbing material; anti-scuffing agent, optionally a silicone or fluoropolymer; light spill-suppressing agent; anti-static agent and water repellant agent, optionally a silicone or fluoropolymer.

43. A method as claimed in claim 33 comprising the additional step of adding a thickener is added to the liquid carrier medium in two steps, namely before and after the addition of the binder and coupler.

44. A studio installation comprising a background or backdrop material as claimed in claim 1, camera means positioned for imaging the backdrop and any subjects positioned in front of the backdrop, means for illuminating the backdrop and any such subjects, and chroma-keying means for processing the images derived from the camera means so as to distinguish foreground subjects from the backdrop by means of light reflected and/or scattered from the backdrop.

45. A method for chroma-keying comprising deploying a coloured background or backdrop material according to claim 1 and imaging with a camera a scene against the backdrop with the backdrop principally illuminated with light from a source or sources away from the camera axis.

46. A method for producing a background or backdrop material according to claim 1, comprising the steps of:
coating the substrate with a binder system; and
subsequently applying the microbeads and/or reflective elements on to said substrate.
